(19) United States
(12) Patent Application Publication
(10) Pub. No.: US 2004/0034868 A1
(43) Pub. Date: Feb. 19, 2004

(54) Contents providing system and contents providing method

(76) Inventor: Tetsu Fukuoka, Tokyo (JP)

Correspondence Address: Rosenthal & Osha L.L.P., Suite 2800, 1221 McKinney, Houston, TX, 77010, US

(21) Appl. No.: 10/219,042

(22) Filed: Aug. 14, 2002

(51) Int. Cl. H04N 7/025; H04N 7/10; G06F 3/00; H04N 5/445; G06F 13/00; H04N 7/16

(52) U.S. Cl. 725/45; 725/35; 725/46

(57) ABSTRACT

The contents providing system 10 comprises a contents package generation unit 14 for generating a contents package containing contents and attribute information, a contents package broadcast unit 28 for broadcasting the contents package, a contents package reception unit 32 for receiving the broadcast contents package, a contents package extraction unit 34 for extracting a specific contents package from among the received contents packages based on the attribute information, a contents package storage unit 36 for storing the specific contents package, a contents package readout unit 38 for reading out the stored contents package and a contents provision unit 42 for providing the readout contents package to the user.

### BACKGROUND OF THE INVENTION

1. Field of the Invention

The present invention pertains to a contents providing system and a contents providing method for providing contents to a user.

2. Related Background Art

Pursuant to the development of telecommunication technology, contents such as video data, still image data and audio data can now be remotely provided to users via the Internet.

### SUMMARY OF THE INVENTION

However, a contents providing system as with the foregoing conventional technology for providing contents to users via the Internet has the following problems. In other words, since a contents providing system according to the conventional technology provides contents to users via the Internet, much communication time is required when trying to provide high-quality video data, still image data or audio data, and it was not possible to provide such data to users within a short period of time.

Accordingly, the present invention aims to resolve the foregoing problems, and an object thereof is to provide a contents providing system and a contents providing method capable of providing desired contents to users within a short period of time.

In order to achieve the foregoing object, the contents providing system according to the present invention is a contents providing system for providing contents to a user, comprising: contents package generation means for generating a contents package containing the contents and attribute information relating to the attribute of the contents; contents package broadcast means for broadcasting the contents package generated by the contents package generation means; contents package reception means for receiving the contents package broadcast by the contents package broadcast means; contents package extraction means for extracting a specific contents package, based on the attribute information, among the contents packages received by the contents package reception means; contents package storage means for storing the specific contents package extracted by the contents package extraction means; contents package readout means for reading out the contents package stored in the contents package storage means; and contents provision means for providing the user with contents contained in the contents package read out by the contents package readout means.

Moreover, in order to achieve the foregoing object, the contents providing method according to the present invention is a contents providing method for providing contents to a user, comprising: a contents package generation step for generating a contents package containing the contents and attribute information relating to the attribute of the contents; a contents package broadcast step for broadcasting the contents package generated in the contents package generation step; a contents package reception step for receiving the contents package broadcast in the contents package broadcast step; a contents package extraction step for extracting a specific contents package, based on the attribute information, from among the contents packages received in the contents package reception step; a contents package storage step for storing the specific contents package extracted in the contents package extraction step; a contents package readout step for reading out the contents package stored in the contents package storage step; and a contents provision step for providing the user with contents contained in the contents package read out in the contents package readout step.

By previously storing the broadcast contents package and reading out such stored contents package upon providing the same to the user, the time required for providing such contents to the terminal device or the like used by the user from the time the user makes a request to the storage means for providing the contents can be shortened. As a result, the desired contents can be provided to the user within a short period of time. Moreover, by providing attribute information to the contents and storing only a specific contents package extracted based on attribute information, it is no longer necessary to provide a high capacity storage means.

### BRIEF DESCRIPTION OF THE DRAWINGS

FIG. 1 is a system structure diagram of the contents providing system;

FIG. 2 is a diagram showing the information contained in the contents package;

FIG. 3 is a diagram showing the structure of the storage area;

FIG. 4 is a flowchart showing the operation of the contents providing system;

FIG. 5 is a flowchart showing the operation of the contents providing system; and

FIG. 6 is a flowchart showing the operation of the contents providing system.

### DESCRIPTION OF THE PREFERRED EMBODIMENTS

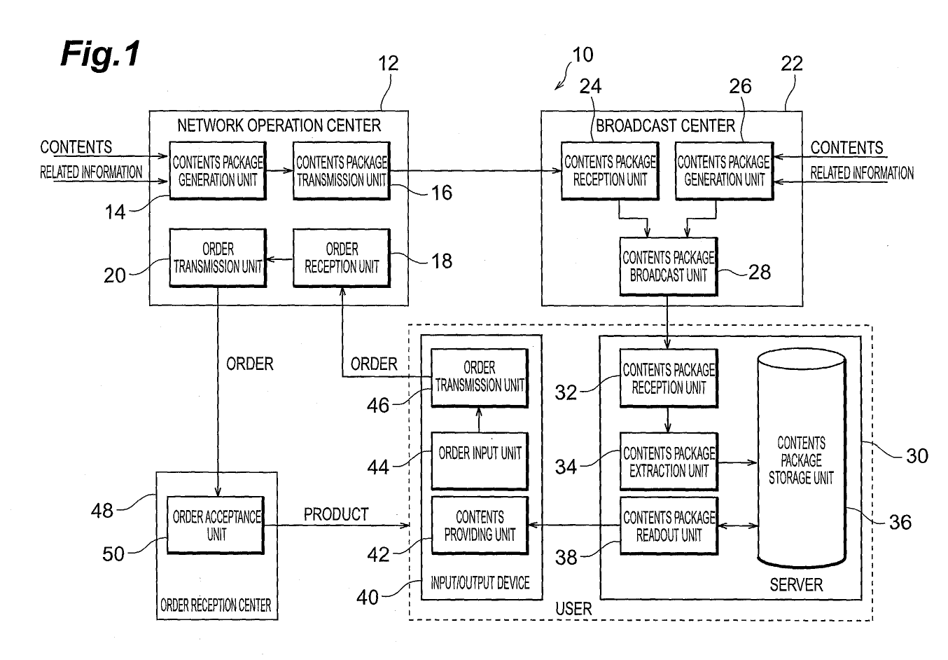

The contents providing system according to the embodiments of the present invention is now explained with reference to the drawings. Foremost, the structure of the contents providing system according to the present embodiment is explained. FIG. 1 is a system structure diagram of the contents providing system according to the present embodiment.

The contents providing system 10 according to the present embodiment is a contents providing system for providing contents to a user. Here, contents shall mean data, for example, video data (moving image data), still image data, audio data (music data) and so on. Further, the contents providing system 10 according to the present embodiment is in particular a contents providing system for providing digital contents of an aggregate of digitized data.

The contents providing system 10 according to the present embodiment is structured by comprising a contents package generation unit 14 (contents package generation means), a contents package transmission unit 16, an order reception unit 18, and an order transmission unit 20 provided to a network operation center 12; a contents package reception unit 24, a contents package generation unit 26 (contents package generation means), and a contents package broadcast unit 28 (contents package broadcast means) provided to a broadcast center 22; a server 30 and an input/output device 40 provided to the user side; and an order reception unit 50 provided to an order acceptance center 48. Here, the user side server 30 is structured by comprising a contents package reception unit 32 (contents package reception means), a contents package extraction unit 34 (contents package extraction means), a contents package storage unit 36 (contents package storage means), and a contents package readout unit 38 (contents package readout means), and the user side input/output device 40 is structured by comprising a contents providing unit 42 (contents providing means), an order input unit 44, and an order transmission unit 46. The respective structural elements are explained in detail below.

The network operation center 12 is a center for managing the overall contents providing system 10, and is physically structured as a facility comprising a data processing computer, telecommunication equipment, and the like.

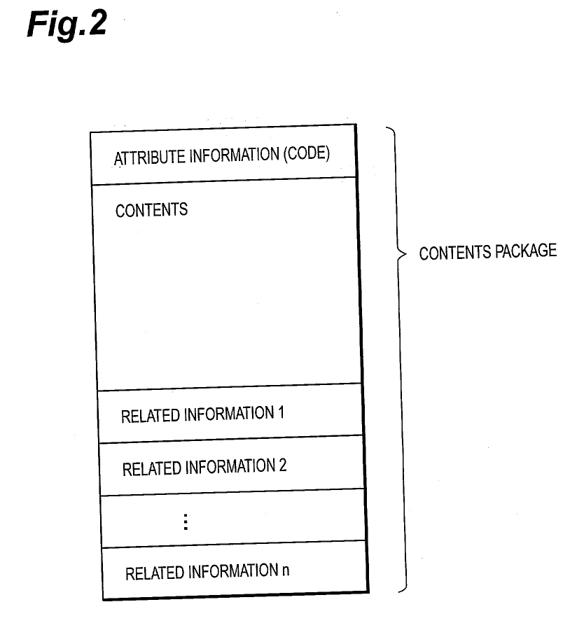

The contents package generation unit 14 of the network operation center 12 generates a contents package containing the contents and attribute information relating to the attribute of such contents. In more detail, the contents package generation unit 14 inputs the contents and the related information thereof provided from the contents provider in order to generate the attribute information of such contents. Moreover, the contents package generation unit 14 generates a contents package, which is an aggregate of data containing the input contents, related information thereof and the generated attribute information. Here, contents shall mean data, for example, video data, still image data, audio data and so on as described above. Moreover, related information shall mean information relating to the contents, and, for example, if the contents are audio data to be used for promoting the sales of CDs, information relating to the transition of the sales volume of such CD, information relating to the price of such CD, and information relating to the artist would fall under such related information. Further, attribute information is information relating to the attribute of the contents, and, in particular, contains type information relating to the type of contents and retention term information relating to the retention term of the contents package containing the contents. Included in the foregoing type information is a data format indicating whether the contents are a video data, still image data or audio data, and information indicating whether the contents relate to sports or to traveling, and, among such sports, whether the contents relate to soccer or baseball. Further, included in the foregoing retention term information is the term during which the contents are to be retained, or the deadline of how long the contents should be retained. In addition, included in the attribute information of a part of the contents package is information for the contents package to be compulsorily extracted by the contents package extraction unit 34 of the server 30 (details to be described later). Here, it is preferable that the foregoing attribute information is coded. By coding the attribute information, the extraction, search or the like of the contents package is facilitated. FIG. 2 illustrates a case where the information contained in the foregoing contents package is represented as a chart. Here, a contents package is generated for the respective contents. Moreover, the number of related information items contained in a single contents package is not limited to one item, and there may be a plurality of items. The contents package generation unit 14 outputs the generated contents package to the contents package transmission unit 16.

The contents package transmission unit 16 transmits the contents package output from the contents package generation unit 14 to the contents package reception unit 24 of the broadcast center 22.

The broadcast center 22 is a center for broadcasting the contents package, and is physically structured as a facility comprising broadcasting equipment and the like. Here, the broadcast center 22 may be a center conducting satellite broadcast by a satellite or a center conducting terrestrial broadcast via a terrestrial relay station. Further, the broadcast center 22 may be a center for conducting broadcast using a cable television network. Moreover, the broadcast center 22 is not limited to one, and, for instance, a plurality of broadcast centers 22 may be provided in different regions.

The contents package reception unit 24 of the broadcast center 22 receives the contents package transmitted from the contents package transmission unit 16 of the network operation center 12. Further, the contents package reception unit 24 outputs the received contents package to the contents package broadcast unit 28.

The contents package generation unit 26 of the broadcast center 22, similar to the contents package generation unit 14 of the network operation center 12, generates a contents package containing the contents and attribute information relating to the attribute of such contents. In more detail, the contents package generation unit 26 inputs the contents provided from the contents provider and the related information thereof in order to generate the attribute information of such contents. Moreover, the contents package generation unit 26 generates a contents package, which is an aggregate of data containing the input contents, related information thereof and the generated attribute information. The contents package generation unit 26 further outputs the generated contents package to the contents package broadcast unit 28. Here, in addition to the network operation center 12 managing the overall contents providing system 10, by providing a contents package generation unit 26 to the broadcast center 22 as well, the broadcast center 22 is able to generate its independent contents package and provide the same to the user. In other words, by additionally providing a contents package generation unit 26 to the broadcast center 22, each of the plurality of broadcast centers 22 provided per region will be able to independently provide users with contents containing local information coherent to the region to which such broadcast center 22 is established.

The contents package broadcast unit 28 broadcasts the contents package generated by the contents package generation unit 14 of the network operation center 12 and the contents package generated by the contents package generation unit 26 of the broadcast center 22. Specifically, the contents package broadcast unit 28 broadcasts the contents package output from the contents package reception unit 24 of the broadcast center 22 and the contents package output from the contents package generation unit 26 of the broadcast center 22. Here, the contents package broadcast unit 28 may broadcast a contents package with satellite broadcasting employing a satellite or may broadcast a contents package with terrestrial broadcasting via a terrestrial relay station. Further, the contents package broadcast unit 28 may broadcast a contents package with a cable television network.

The server 30 is disposed on the user side, and is a server for accumulating contents packages, and is physically structured with the likes of a storage device such as a hard disk, a central processing unit (CPU) for controlling such storage device, and so on.

The contents package reception unit 32 of the server 30 receives the contents package broadcast by the contents package broadcast unit 28 of the broadcast center 22. The contents package reception unit 32 further outputs the received contents package to the contents package extraction unit 34.

The contents package extraction unit 34 extracts a specific contents package, based on attribute information, among the contents packages received by the contents package reception unit 32. In more detail, the contents package extraction unit 34, based on the type information contained in the attribute information, extracts a specific type of contents package complying with the conditions predetermined by the user. That is, in a case where the user predetermines a condition of extracting a contents package relating to new songs of Japanese rock singers, the contents package extraction unit 34 refers to the type information contained in the attribute information, and extracts the contents package relating to new songs of Japanese rock singers. Moreover, the contents package extraction unit 34 compulsorily extracts a contents package having attribute information containing information for performing compulsory extraction. As described above, by compulsorily extracting a certain contents package, for instance, a contents package containing contents relating to the advertisement of a sponsor company can be compulsorily extracted regardless of the conditions set forth by the user.

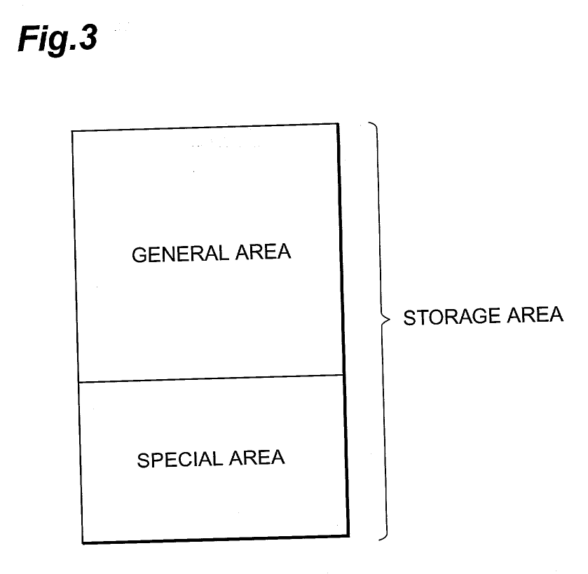

The contents package storage unit 36 stores a specific contents package extracted by the contents package extraction unit 34. Here, in particular, the storage area of the contents package storage unit 36 is divided into a general area and a special area as shown in FIG. 3. Here, a general area is an area storing a specific type of contents package complying with the conditions predetermined by the user among the content packages extracted by the contents package extraction unit 34. That is, for example, in a case where the user predetermines a condition of extracting a contents package relating to new songs of Japanese rock singers, the contents package relating to new songs of Japanese rock singers is stored in the general area. Meanwhile, a special area is an area storing the compulsorily extracted contents package among the content packages extracted by the contents package extraction unit 34. That is, contents packages where information (an address within the special area for example) for performing compulsorily extraction is contained in the foregoing attribute information are stored in the special area. As described above, by providing a special area for compulsorily storing a specific contents package in the contents package storage unit 36, a contents package containing contents relating to the advertisement of a sponsor company can be compulsorily stored in the contents package storage unit 36 regardless of the conditions set forth by the user. In other words, by providing a special area for compulsorily storing a specific contents package in the contents package storage unit 36, a certain area within the special area may be assigned to a specific company such as a sponsor upon designating the capacity of use, period of use, and so on. Thereby, fees for using the storage area may be collected from the specific company such as a sponsor. The contents package storage unit 36 further deletes the contents package based on the retention term information contained in the attribute information of the contents package. In other words, for instance, when an indication such as “delete two months after storage” is contained as information in the retention term information, the contents package storage unit 36 deletes the contents package after two months have elapsed from the storage of the contents package. In addition, when there is no free space in the storage area of the contents package storage unit 36 because it is full of contents packages, the contents package storage unit 36 notifies this to the user and deletes a specific contents package in accordance with the instructions of the user.

The contents package readout unit 38 reads out the contents package stored in the contents package storage unit 36. Here, the contents package readout unit 38 also possesses the function of searching the contents package based on the foregoing attribute information. The contents package readout unit 38 further extracts contents from the readout contents packages and outputs such contents to the contents providing unit 42 of the input/output device 40.

The input/output device 40 is a device for providing (outputting) contents to the user and inputting purchase orders and the like of products from the user to the network operation center 12, and is physically structured from the likes of a personal computer or digital television comprising a display, speaker, mouse, keyboard, modem and so on.

The contents providing unit 42 of the input/output device 40 provides the user with contents contained in the contents package readout by the contents package readout unit 38 of the server 30. More specifically, when the contents contain video data, the contents providing unit 42 displays such video data on the display. Moreover, when the contents contain audio data, the contents providing unit 42 plays such audio data from the speaker. Here, simultaneously with providing the foregoing contents, the contents providing unit 42 indicates on the display an icon or the like for reading out the contents package compulsorily extracted by the contents package extraction unit 34 and compulsorily stored in the special area of the contents package storage unit 36. Here, when such icon is clicked, the contents package readout unit 38 reads out the foregoing compulsorily extracted and compulsorily stored contents package from the contents package storage unit 36, and the contents providing unit 42 provides the contents contained in such contents package to the user. As described above, by indicating on the display an icon or the like for reading out the compulsorily extracted and compulsorily stored contents package and providing such contents package to the user when the icon is clicked, for example, contents relating to the advertisement of the sponsor company can be provided to the user comparatively easily.

The order input unit 44 accepts the input of a purchase order of products from the user. In other words, the order input unit 44 in particular accepts the input of a purchase order of the user resulting and arising from the contents provided by the contents providing unit 42. For example, when music to be used for promoting the sales of CDs is provided by the contents providing unit 42, the order input unit 44 accepts the input of a purchase order of such CD from the user. The order input unit 44 outputs the accepted purchase order to the order transmission unit 46.

The order transmission unit 46 transmits the purchase order output from the order input unit 44 to the order reception unit 18 of the network operation center 12. Such transmission is conducted via the Internet, phone line, cable television network, or the like.

The order reception unit 18 of the network operation center 12 receives the purchase order transmitted from the order transmission unit 46 of the input/output device 40, and outputs the received purchase order to the order transmission unit 20. Thereupon, the order reception unit 18 may accumulate the history of the received purchase order per user and structure an order-history database.

The order transmission unit 20 transmits the purchase order output from the order reception unit 18 to the order reception unit 50 of the order acceptance center 48. Such transmission is conducted via the Internet, phone line, cable television network, or the like.

The order acceptance center 48 is a center for receiving the purchase order of products and outputting delivery instructions for delivery such products to the user, and is physically structured as a facility comprising a data processing computer, telecommunication equipment, and the like. The order acceptance center 48 may be provided for each provider of products or may be shared by a plurality of providers of products.

The order reception unit 50 of the order acceptance center 48 receives purchase orders transmitted from the order transmission unit 20 of the network operation center 12. Moreover, the order reception unit 50 outputs the delivery instructions of the product pertaining to the received purchase order. Here, the product of the purchase order is delivered to the user based on such delivery instructions.

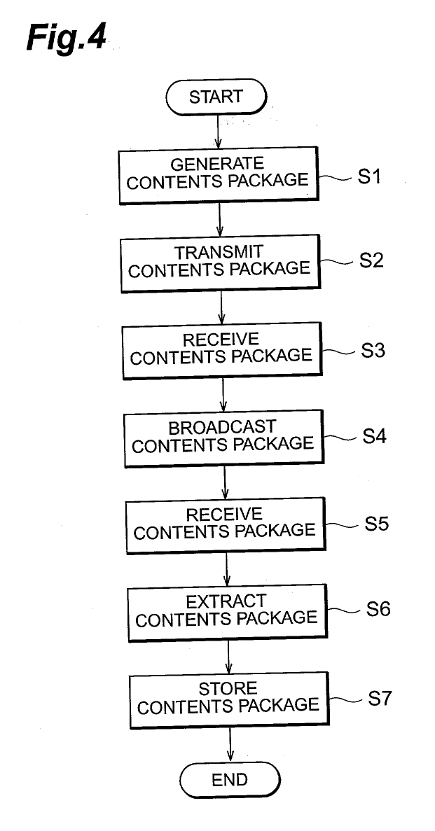

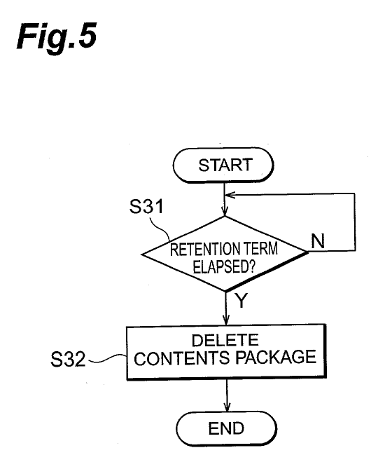

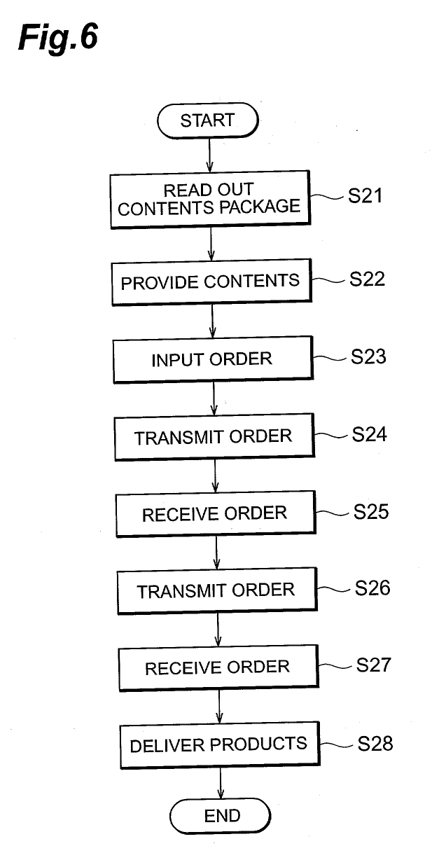

Next, the operation of the contents providing system according to the present embodiment will be explained and, pursuant thereto, the contents providing method according to an embodiment of the present invention will also be explained. FIG. 4 through FIG. 6 are flowcharts for illustrating the operation of the contents providing system according to the present embodiment. Here, in particular, FIG. 4 is a flowchart illustrating the procedures for the generation, broadcast and storage of the contents package in the contents providing system according to the present embodiment, FIG. 5 is a flowchart illustrating the procedures for deleting the contents package, and FIG. 6 is a flowchart illustrating the procedures of providing the contents and the procedures from the input of purchase orders to the delivery of products.

The procedures for the generation, broadcast and storage of the contents package in the contents providing system 10 are as follows.

When contents are provided to the network operation center 12, as shown in FIG. 4, the contents package generation unit 14 generates a contents package containing the contents and attribute information relating to the attribute of such contents (S1). In more detail, when the contents and the related information of such contents provided from the contents provider are input in the contents package generation unit 14, such contents package generation unit 14 generates attribute information of such contents. When the attribute information is generated, the contents package generation unit 14 generates a contents package, which is an aggregate of data containing the input contents, related information and generated attribute information. Here, contents shall mean data, for example, video data, still image data, audio data and so on as described above. Moreover, related information shall mean information relating to the contents, and, for example, if the contents are audio data to be used for promoting the sales of CDs, information relating to the transition of the sales volume of such CD, information relating to the price of such CD, and information relating to the artist would fall under such related information. Further, attribute information is information relating to the attribute of the contents, and, in particular, contains type information relating to the type of contents and retention term information relating to the retention term of the contents package containing the contents. Included in the foregoing type information is a data format indicating whether the contents are a video data, still image data or audio data, and information indicating whether the contents relate to sports or to traveling, and, among such sports, whether the contents relate to soccer or baseball. Further, included in the foregoing retention term information is the term during which the contents are to be retained, or the deadline of how long the contents should be retained. In addition, included in the attribute information of a part of the contents package is information for the contents package to be compulsorily extracted by the contents package extraction unit 34 of the server 30. The generated contents package is output from the contents package generation unit 14.

The contents package output from the contents package generation unit 14 is input to the contents package transmission unit 16, and transmitted to the contents package reception unit 24 of the broadcast center 22 (S2).

The contents package transmitted from the contents package transmission unit 16 of the network operation center 12 is received by the contents package reception unit 24 of the broadcast center 22 (S3), and output from such contents package reception unit 24 to the contents package broadcast unit 28.

Meanwhile, the contents package is also generated by the contents package generation unit 26 of the broadcast center 22. In other words, when the contents and the related information of such contents provided from the contents provider are input in the contents package generation unit 26, foremost, such contents package generation unit 26 generates attribute information of such contents. When the attribute information is generated, the contents package generation unit 26 generates a contents package, which is an aggregate of data containing the input contents, related information and generated attribute information, and such contents package is output to the contents package broadcast unit 28.

When the contents package received by the contents package reception unit 24 and the contents package generated by the contents package generation unit 26 are input into the contents package broadcast unit 28, such contents packages are broadcast by the contents package broadcast unit 28 (S4).

The contents package broadcast by the contents package broadcast unit 28 of the broadcast center 22 is received by the contents package reception unit 32 of the user server 30 (S5), and output to the contents package extraction unit 34.

When the contents package received by the contents package reception unit 32 is input into the contents package extraction unit 34, such contents package extraction unit 34 extracts a specific contents package, based on attribute information, among the contents packages received by the contents package reception unit 32 (S6). In more detail, the contents package extraction unit 34, based on the type information contained in the attribute information of the contents package, extracts a specific type of contents package complying with the conditions predetermined by the user. That is, in a case where the user predetermines a condition of extracting a contents package relating to new songs of Japanese rock singers, the contents package extraction unit 34 refers to the type information contained in the attribute information, and extracts the contents package relating to new songs of Japanese rock singers. Moreover, when the attribute information contains information for compulsorily extracting the contents package, such contents package is compulsorily extracted by the contents package extraction unit 34.

The contents package extracted by the contents package extraction unit 34 is stored in the contents package storage unit 36 (S7). Here, in particular, the storage area of the contents package storage unit 36 is divided into a general area and a special area as shown in FIG. 3. Among the contents packages extracted by the contents package extraction unit 34, a specific type of contents package complying with the conditions predetermined by the user (for example, the contents package relating to new songs of Japanese rock singers when conditions for extracting the contents package relating to new songs of Japanese rock singers are predetermined by the user) is stored in the foregoing general area, and, among the contents packages extracted by the contents package extraction unit 34, the compulsorily extracted contents packages are stored in the foregoing special area.

The procedures for deleting contents packages are as follows.

Retention term information of a contents package is contained in the attribute information of such contents package stored in the contents package storage unit 36. When the contents package is stored in the contents package storage unit 36, as shown in FIG. 5, the foregoing retention term information is periodically referred to for judging whether or not such contents package is stored in the contents package storage unit 36 beyond the retention term (S31). Here, if the contents package is stored in the contents package storage unit 36 beyond the retention term, such contents package will be deleted (S32). In other words, for instance, when an indication such as “delete two months after storage” is contained as information in the retention term information, the contents package is deleted after two months have elapsed from the storage of such contents package. In addition, when there is no free space in the storage area of the contents package storage unit 36 because it is full of contents packages, the contents package 36 notifies this to the user and deletes a specific contents package in accordance with the instructions of the user.

The procedures of providing the contents and the procedures from the input of purchase orders to the delivery of products are as follows.

When the user requests the provision of contents, as shown in FIG. 6, the contents package readout unit 38 reads out the contents package stored in the contents package storage unit 36 (S21). When the contents package is read out, contents are extracted from the readout contents package, and such contents are output to the contents providing unit 42 of the input/output device 40.

The contents output from the contents package readout unit 38 are provided to the user from the contents providing unit 42 (S22). More specifically, when the contents contain video data, such video data is indicated on the display, and, when the contents contain audio data, such audio data is played from the speaker. Here, simultaneously with the foregoing contents being provided to the user, an icon or the like is indicated on the display for reading out the contents package compulsorily extracted by the contents package extraction unit 34 and compulsorily stored in the special area of the contents package storage unit 36. By clicking such icon, the user is able to receive the provision of contents contained in the compulsorily extracted and compulsorily stored contents package.

When the user wishes to input a purchase order of a product resulting from the contents (does not matter whether or not such purchase order results from the contents) provided from the contents providing unit 42, the user may use a mouse or keyboard to input such purchase order of the product (S23). The input purchase order is accepted by the order input unit 44, and output to the order transmission unit 46.

The purchase order input to the order transmission unit 46 is transmitted from such order transmission unit 46 to the order reception unit 18 of the network operation center 12 (S24), and received by such order reception unit 18 (S25).

The purchase order received by the order reception unit 18 of the network operation center 12 is output to the order transmission unit 20, and transmitted from the order transmission unit 20 to the order reception unit 50 of the order acceptance center 48 (S26). Such transmission is conducted via the Internet, phone line, cable television network, or the like. Thereupon, the history of the purchase order received by the (order reception unit 18 of the) network operation center may be accumulated per user in order to structure an order-history database.

Purchase orders transmitted from the order transmission unit 20 of the network operation center 12 are received by the order reception unit 50 of the order acceptance center 48 (S27). When the order reception unit 50 of the order acceptance center 48 receives the purchase orders, the order reception unit 50 outputs the delivery instructions of the product pertaining to the received purchase order, and the product of the purchase order is delivered to the user based on such delivery instructions (S28).

Next, the effects and advantages of the contents providing system according to the present embodiment are explained. The contents providing system 10 according to the present embodiment previously stores the broadcast contents package in the contents package storage unit 36 provided to the user side server 30, reads out the stored contents package with the contents package readout unit 38, and thereby provides such contents package to the user. Therefore, the time required for providing such contents to the input/output device 40 used by the user from the time the user makes a request to the contents package storage unit 36 for providing the contents can be shortened. As a result, the desired contents can be provided to the user within a short period of time.

Further, the contents providing system 10 according to the present embodiment uses contents package generation units 14, 26 to generate contents packages in which attribute information is added to the contents, and stores the specific contents package extracted by the contents package extraction unit 34 based on such attribute information in the contents package storage unit 36 provided to the user side server 30. Thus, since it is not necessary to store all of the contents packages to be broadcast in the contents package storage unit 36 provided to the user side server 30, it is no longer necessary to provide a high capacity server or the like to the user side. As a result, the construction fee for servers and the like on the user side may be reduced.

Moreover, with the contents providing system 10 according to the present embodiment, the contents package readout unit 38 reads out the contents package based on attribute information. Therefore, the contents package can be searched easily, and the time required for searching the desired contents package can be shortened. As a result, desired contents may be provided to the user in an extremely short period of time.

Further, with the contents providing system 10 according to the present embodiment, the contents package extraction unit 34 extracts a specific contents package based on type information. Therefore, excluding the contents packages compulsorily stored in the contents package storage unit 36, only the type of contents package desired by the user may be stored in the contents package storage unit 36. As a result, the type of contents package desired by the user can be stored efficiently in the contents package storage unit 36.

Moreover, with the contents providing system according to the present embodiment, the contents package storage unit 36 deletes contents packages based on retention term information. Therefore, by deleting the unwanted contents packages from the contents package storage unit 36, the storage capacity of the contents package storage means 36 maybe increased. As a result, the contents package storage unit 36 can be used efficiently.

What is claimed is:

1. A contents providing system for providing contents to a user, comprising:
contents package generation means for generating a contents package containing said contents and attribute information relating to the attribute of said contents;
contents package broadcast means for broadcasting said contents package generated by said contents package generation means;
contents package reception means for receiving said contents package broadcast by said contents package broadcast means;
contents package extraction means for extracting a specific contents package, based on said attribute information, from among said contents packages received by said contents package reception means;
contents package storage means for storing said specific contents package extracted by said contents package extraction means;
contents package readout means for reading out said contents package stored in said contents package storage means; and
contents provision means for providing the user with contents contained in said contents package read out by said contents package readout means.

2. A contents providing system according to claim 1, wherein said contents package readout means reads out said contents package stored in said contents package storage means based on said attribute information.

3. A contents providing system according to claim 1, wherein said attribute information contains type information relating to types of said contents, and said contents package extraction means extracts a specific type of contents package, based on said type information, from among said contents packages received by said contents package reception means.

4. A contents providing system according to claim 1, wherein said attribute information contains retention term information relating to the retention term of said contents package, and said contents package storage means deletes said contents package based on said retention term information.

5. A contents providing method for providing contents to a user, comprising:
a contents package generation step for generating a contents package containing said contents and attribute information relating to the attribute of said contents;
a contents package broadcast step for broadcasting said contents package generated in said contents package generation step;
a contents package reception step for receiving said contents package broadcast in said contents package broadcast step;
a contents package extraction step for extracting a specific contents package, based on said attribute information, from among said contents packages received in said contents package reception step;
a contents package storage step for storing said specific contents package extracted by said contents package extraction means;
a contents package readout step for reading out said contents package stored in said contents package storage step; and
a contents provision step for providing the user with contents contained in said contents package read out in said contents package readout step.

6. A contents providing method according to claim 5, wherein said contents package readout step reads out said contents package stored in said contents package storage step, based on said attribute information.

7. A contents providing method according to claim 5, wherein said attribute information contains type information relating to types of said contents, and said contents package extraction step extracts a specific type of contents package, based on said type information, from among said contents packages received in said contents package reception step.

8. A contents providing method according to claim 5, wherein said attribute information contains retention term information relating to the retention term of said contents package, and said method further comprises a contents package deletion step for deleting said contents package stored in said contents package storage step, based on said retention term information.
